(19) United States
(12) Patent Application Publication
(10) Pub. No.: US 2022/0405334 A1
(43) Pub. Date: Dec. 22, 2022

(54) SYSTEM AND METHOD FOR INTELLIGENTLY RECOMMENDING RELEVANT FACET OPTIONS FOR SEARCH RESULTS

(71) Applicant: ADOBE INC., SAN JOSE, CA (US)

(72) Inventors: RYAN TIMOTHY ROZICH, Austin, TX (US); Ajinkya Gorakhnath Kale, San Jose, CA (US); Fahd Murtuza Siddiqui, Cedar Park, TX (US); Ryan Michael Manor, Austin, TX (US); Anna Vladimirova Hammond, Austin, TX (US); Charles Katili, Cedar Park, TX (US)

(21) Appl. No.: 17/349,451

(22) Filed: Jun. 16, 2021

(51) Int. Cl. G06F 16/9532; G06F 16/951; G06F 16/9035; G06F 16/954

(52) U.S. Cl. CPC G06F 16/9532; G06F 16/951; G06F 16/9035; G06F 16/954

(57) ABSTRACT

Methods, apparatuses, and systems for content management and search refinement are described. Embodiments of the present disclosure include search refinement systems configured to identify the most relevant data attributes (e.g., facets) for filtering search results. For example, a user may provide a search query, and a search engine may retrieve a set of search results in addition to providing facets (e.g., data attributes associated with search result objects from the retrieved set of search results) for user search refinement of the retrieved search results. In some embodiments, facets are scored using a significance heuristic, which is used to determine and select facets that provide the most information gain given a set of search results. Selected facets may be presented to a user as filtering options for narrowing a retrieved set of results.

### BACKGROUND

The following relates generally to content management, and more specifically to search refinement.

Content management refers to the set of processes or technologies for the collection, delivery, retrieval and management of information. Content management techniques can be used for content access, search, and refinement. For example, a search engine can be programmed to receive a query, perform content search, and retrieve the most relevant results corresponding to the received query. Computer software used for content management can provide rules for search refinement that are broad and generally applicable to multiple categories. Alternatively, content management software can customize rules of refinement for each category. In some examples, software configures rules for refinement that are based on conditional logic.

In addition to providing relevant search results, a search engine may return relevant facet (e.g., filter) options to enable users to refine provided search results. Search facet options may refer to a set of product attributes that are displayed to the user (e.g., to an online searcher) as options to filter or refine the retrieved search results. In some examples, providing search facet options as part of a search results page plays a critical role in how users are able narrow search results and ultimately find desired search results through the search platform. For example, providing search facets may enable browsers to more efficiently narrow search catalog listings in order to find desired products.

However, some search platforms may rely on manually created facets or facet generation that adheres to rules or conditional logic. In such cases, the facets can be based on defined categories, and may only apply only to certain search queries, etc. Such facets may have lower applicability to niche product categories, changes in user tastes, less common search query string, etc. Filtering search results with less applicable facets may not return relevant and useful results, causing in less effective search refinement. In such cases where users are unable to efficiently retrieve relevant search results, users may discontinue using the search engine or find products or information that are less suitable for their needs. Therefore, there is a need in the art for improved search engine facet determination and effective dynamic search refinement.

### SUMMARY

The present disclosure describes systems and methods for content management and search refinement. Embodiments of the present disclosure include search refinement systems configured to identify the most relevant data attributes (i.e., facets) for filtering search results. For example, a user may provide a search query, and a search engine may retrieve a set of search results in addition to providing facets (e.g., data attributes associated with search result objects from the retrieved set of search results) for refinement of the retrieved search results. In some embodiments, facets are scored using a significance heuristic, which is used to select facets that provide the most information gain given a set of search results. Selected facets may be presented to a user as filtering options for narrowing a retrieved set of results.

A method, apparatus, non-transitory computer readable medium, and system for search refinement are described. One or more embodiments of the method, apparatus, non-transitory computer readable medium, and system include receiving a search query, retrieving a plurality of search result objects from among a plurality of search candidate objects based on the search query, and identifying an attribute associated with a search result object from the plurality of search result objects. One or more embodiments of the method, apparatus, non-transitory computer readable medium, and system further include computing an information gain value for the attribute using a significance heuristic based on a frequency of the attribute among the plurality of search result objects and a frequency of the attribute among the plurality of search candidate objects, selecting the attribute as a filter for the plurality of search result objects based on the information gain value, and filtering the plurality of search result objects based on a value of the attribute.

A method, apparatus, non-transitory computer readable medium, and system for search refinement are described. One or more embodiments of the method, apparatus, non-transitory computer readable medium, and system include identifying an attribute associated with a search result object from a plurality of search result objects, where the plurality of search result objects is selected from a plurality of search candidate objects. One or more embodiments of the method, apparatus, non-transitory computer readable medium, and system further include computing an information gain value for the attribute using a significance heuristic based on a frequency of the attribute among the plurality of search result objects and a frequency of the attribute among the plurality of search candidate objects, and selecting the attribute as a filter for the plurality of search result objects based on the information gain value.

An apparatus, system, and method for search refinement are described. One or more embodiments of the apparatus, system, and method include an attribute identification component configured to identify an attribute associated with a search result object from a plurality of search result objects, where the plurality of search result objects is selected from a plurality of search candidate objects. One or more embodiments of the apparatus, system, and method further include a significance component configured to compute an information gain value for the attribute using a significance heuristic based on a frequency of the attribute among the plurality of search result objects and a frequency of the attribute among the plurality of search candidate objects. One or more embodiments of the apparatus, system, and method further include a filter component configured to select the attribute as a filter for the plurality of search result objects based on the information gain value, and to filter the plurality of search result objects based on a value of the attribute.

### BRIEF DESCRIPTION OF THE DRAWINGS

FIG. 1 shows an example of a product search system according to aspects of the present disclosure.

FIG. 2 shows an example of a product search dataflow according to aspects of the present disclosure.

FIG. 3 shows an example of a process for product filtering according to aspects of the present disclosure.

FIG. 4 shows an example of a user interface for search filtering according to aspects of the present disclosure.

FIG. 5 shows an example of a search filtering apparatus according to aspects of the present disclosure.

FIG. 6 shows an example of a search filtering diagram according to aspects of the present disclosure.

FIG. 7 shows an example of a process for attribute selection according to aspects of the present disclosure.

FIG. 8 shows an example of a process for computing information gain according to aspects of the present disclosure.

### DETAILED DESCRIPTION

The present disclosure describes systems and methods for content management and search refinement. Embodiments of the present disclosure include search refinement systems configured to identify the most relevant data attributes (i.e., facets) associated with search result objects from a set of retrieved search results (e.g., where the identified facets may be used for further filtering of the set of retrieved search results). In some embodiments, facets are scored using a significance heuristic, such that facets providing the most information gain may be selected given the retrieved set of search results. Selected facets may be presented to a user as filtering options for narrowing or refining the set of retrieved search results.

Databases and search engines may implement content management techniques to improve search refinement and filter search results. For instance, in addition to retrieving a set of relevant search results, search facet options (e.g., a set of data attributes associated with retrieved search results) may be displayed to the user as filter options to refine retrieved search results. In many cases, the facets (e.g., filter options) presented to users is critical to how users narrow retrieved search results.

In the context of a user searching for products online, selection and presentation of certain facets may play a large role in the user's ability to find and purchase desired products. In some cases, search platforms provide rules for facet selection that are universally applicable to multiple product listings (e.g., search results and category listings). Alternatively, some search platforms customize rules for facet selection in different product categories based on conditional logic (e.g., such that a different set of facets is presented for different queries). Such manually created facets or facets generated based on rigid rules or conditional logic may only apply only to certain search queries or certain product categories, may have lower applicability to niche product categories or less common search query string, etc. Moreover, less applicable facets provided in such scenarios may not return relevant and useful filtered results (e.g., resulting in less effective search refinement, loss of conversions, etc.). As a result, these facet selection systems may not be scalable to new product categories and may not perform effective real-time filtering of retrieved search results.

Embodiments of the present disclosure include search refinement systems and search refinement methods configured to identify the most relevant and useful data attributes (e.g., facets) for filtering search results. In some examples, anomaly detection is used in order to identify the most relevant or useful facet options for a retrieved search result set. Further, information gain (e.g., using aspects of information theory) may be leveraged to identify the attributes that best discriminate the products in the result set from the rest of the product catalog. For instance, anomaly detection may be used to select facets (e.g., categorical features of search result objects) that are common within the retrieved set of search result objects, but are relatively uncommon within the overall catalog or database of search objects. Accordingly, a set of facet/filter options may be selected with improved relevancy (e.g., for any search on any product catalog).

As described in more detail herein, to efficiently sort the facet attributes that are most descriptive and relevant to the result set at query time, each facetable candidate attribute contained in the search results may be scored according to a significance heuristic. A significance heuristic is a measure of how much the facet attribute can help split or distinguish the retrieved search result set (e.g., retrieved search result objects) from the catalog as a whole (e.g., from all search candidate objects). The more overrepresented the facet is in the retrieved search result set versus the catalog as a whole, the higher the score for the facet. Higher scored facets are considered more significant and relevant for the search result set (e.g., and thus the higher scored facets are more likely to be selected and displayed).

Accordingly, techniques described herein may be implemented to identify the most relevant facets for a set of retrieved search results. Facets selected for search refinement filtering may be improved for large and complex category hierarchies, and real-time dynamic faceting for new queries belonging to any product category may be provided. In some examples, techniques described herein may be performed online to identify facet attributes that best describe search results including product attributes that are facetable candidate attributes. For example, in the context of category browsing experiences for online stores, facet determination and selection techniques described herein may be efficient and robust to changes in product catalogs, search preferences, etc.

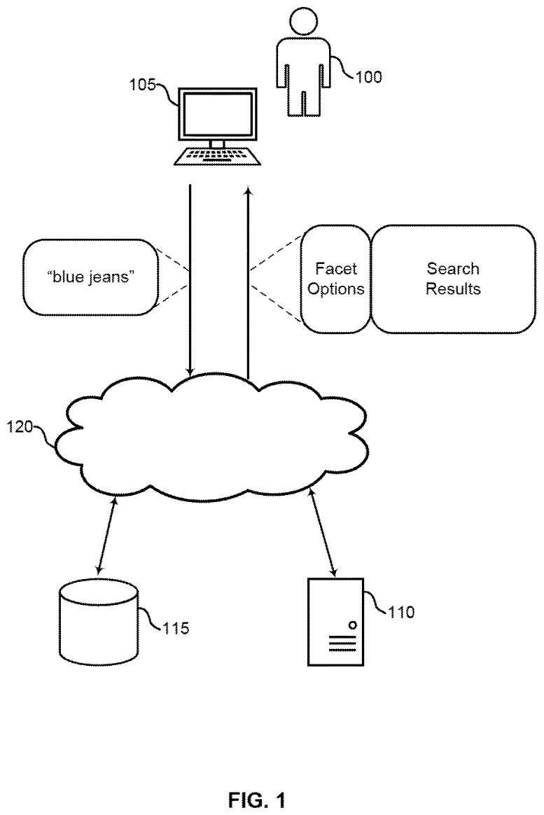

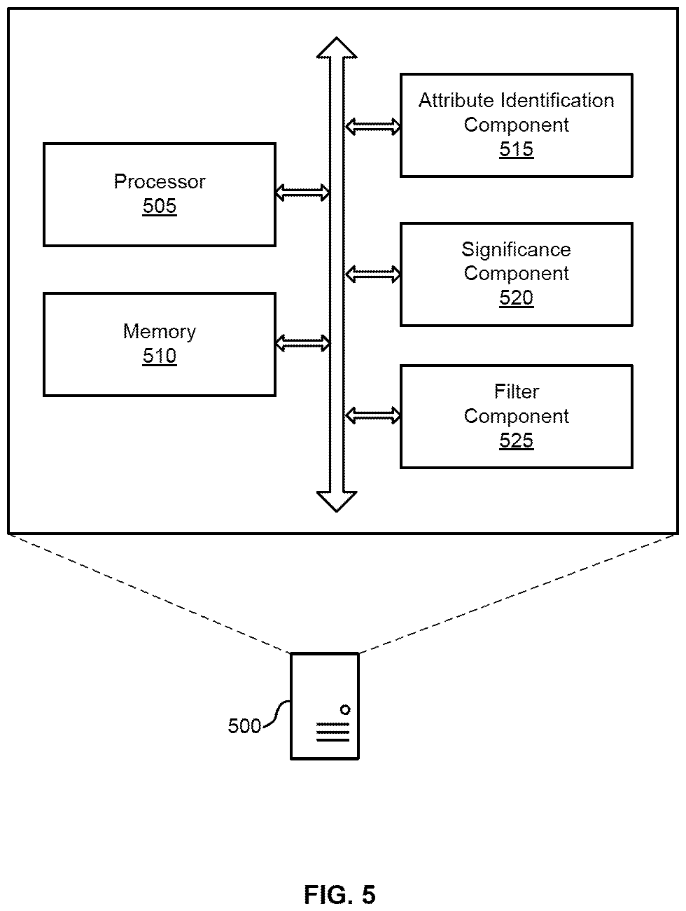

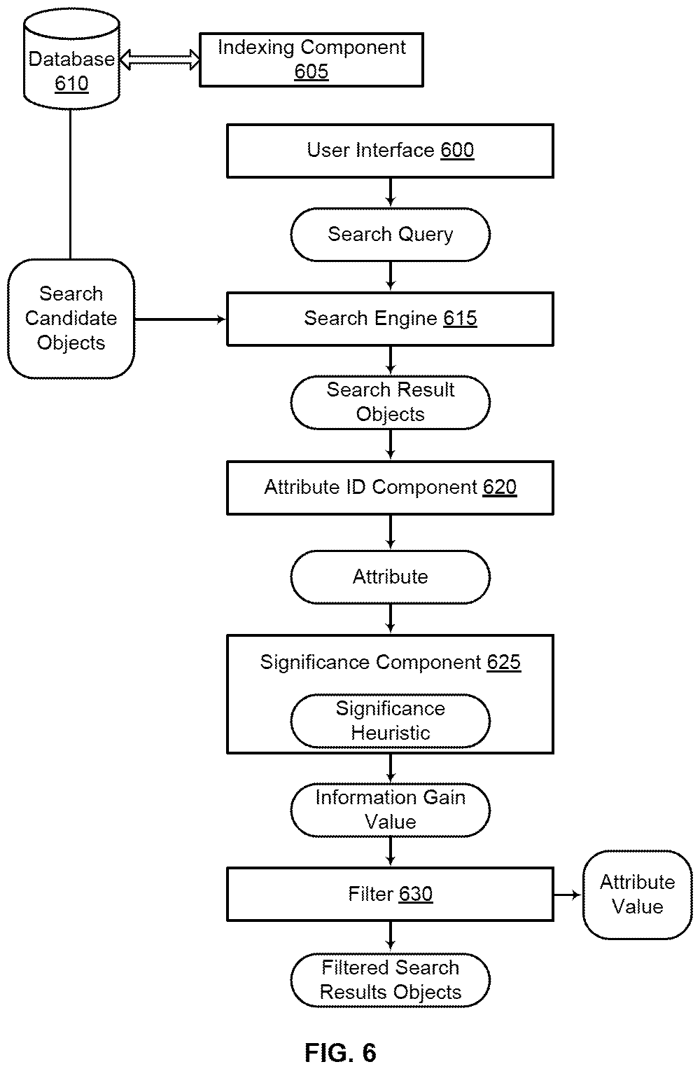

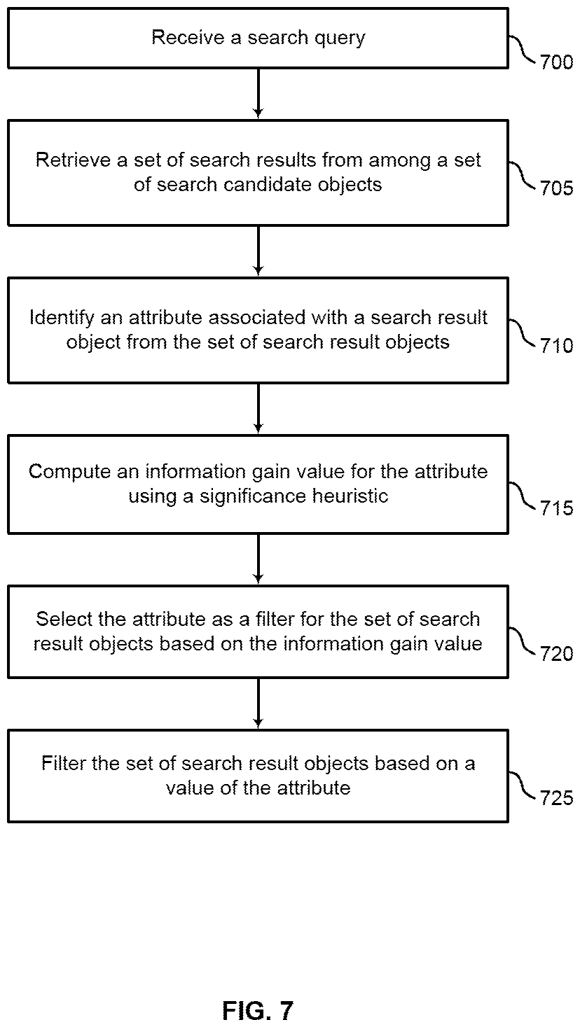

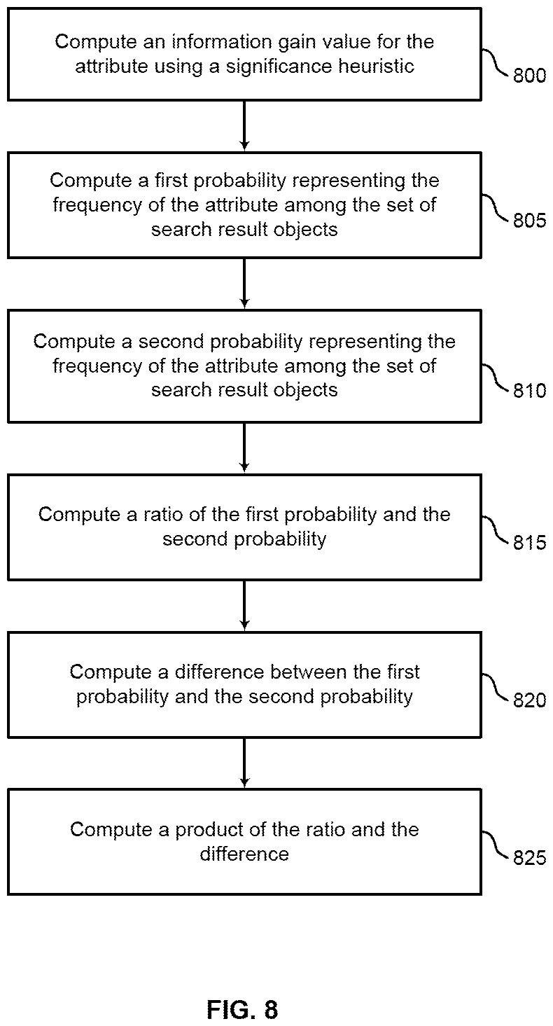

Embodiments of the present disclosure may be used in the context of a search engine used to retrieve results from a product database. For example, a search filtering system based on the present disclosure may take natural language text as a query and search through a database or catalog of search candidate objects to retrieve a set of search results based on the search query. The search filtering system may further select facets (e.g., attributes associated with search result objects of the retrieved set of search results) based on information gain values computed for the facets. An example of an application of the inventive concept in a product search context is provided with reference to FIGS. 1-4. Details regarding the architecture of an example search filtering apparatus and network are provided with reference to FIGS. 5 and 6. Examples of a processes for attribute (e.g., facet) selection is then described with reference to FIGS. 7 and 8.

FIG. 1 shows an example of a product search system according to aspects of the present disclosure. The example shown includes user 100, device 105, search filtering apparatus 110, database 115, and cloud 120. Search filtering apparatus 110 is an example of, or includes aspects of, the corresponding element described with reference to FIG. 5.

A user 100 communicates with a search filtering apparatus 110 via a user device 105 and a cloud 120 to search a product catalog. For example, the user 100 may provide a search query such as a text query or an image query. In the example illustrated in FIG. 1, the search query includes a natural language query “blue jeans.” The user device 105 transmits the search query to the search filtering apparatus 110 to find (e.g., retrieve) related information or search result objects (i.e., search objects stored within the database 115). For instance, in some examples, database 115 may include or store a plurality of search candidate objects. According to techniques described herein, search filtering apparatus 110 may retrieve a plurality of search results (e.g., search result objects) from among a plurality of search candidate objects (e.g., stored in a catalog or database 115) based on a received search query. In some examples, the user device 105 communicates with the search filtering apparatus 110 via the cloud 115.

For example, in FIG. 1, a retrieved search result set includes search result objects corresponding to the received “blue jeans” search query. The search result objects are retrieved (e.g., by search filtering apparatus 110) from a plurality of search candidate objects that are included in a catalog, in database 115, etc. In some cases, the search result objects may include product information, such as product images and product description text, associated with the “blue jeans” search query.

Further, according to the techniques described herein, retrieved search result objects may be provide or displayed in addition to one or more facets (e.g., which may be referred to as facet options, facet attributes, search facets, filter options, data attributes, etc.). Facets may generally include a set of product attributes displayed to a user 100 as options to filter or further refine retrieved search results. For example, facets may include one or more attributes associated with one or more retrieved search result objects. Accordingly, a search filtering apparatus 110 may retrieve search result objects (e.g., from a catalog or database of search candidate objects) that are relevant to a user query, and one or more facets may additionally be provided or displayed such that a user 100 may efficiently filter and/or refine the retrieved search result objects by selecting facets or adjusting values of the facets.

In the example of FIG. 1, the search query is a natural language query and the retrieved search result objects may include various media types such as any combination of audio files, video files, image files, text files, etc. For instance, the retrieved search result objects may include product images and corresponding product description text. However, other types of search queries and retrieved search result objects may be used. In some examples, the search query is of a different media type than the search objects. For example, the query can be a natural language query and the search objects can be images. In some examples, the search query is of a same media type as the retrieved search result objects.

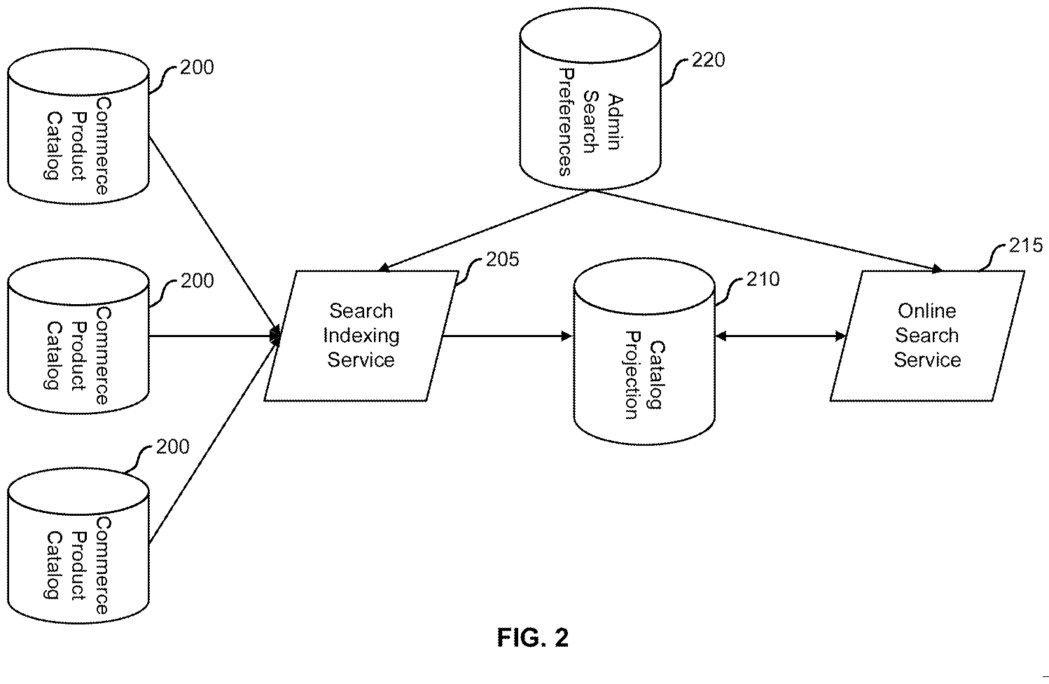

A device 105 may include a personal computer, laptop computer, mainframe computer, palmtop computer, personal assistant, mobile device 105, or any other suitable processing apparatus. According to some embodiments, database 115 is configured to store the plurality of search candidate objects. In some cases, database 115 may include or refer to a catalog (e.g., one or more product catalogs). Database 115 is an example of, or includes aspects of, the corresponding element described with reference to FIGS. 2 and 6.

In some examples, search filtering apparatus 110 and/or device 105 may include or implement software. Software may include code to implement aspects of the present disclosure. Software may be stored in a non-transitory computer-readable medium such as system memory or other memory. In some cases, the software may not be directly executable by the processor but may cause a computer (e.g., when compiled and executed) to perform functions described herein.

In some examples, search filtering apparatus 110 and/or device 105 may include or implement natural language processing (NLP) techniques for using computers to interpret natural language. In some cases, NLP tasks involve assigning annotation data such as grammatical information to words or phrases within a natural language expression. Different classes of machine-learning algorithms have been applied to NLP tasks. These algorithms may take a set of features generated from the natural language data as input. Some algorithms, such as decision trees, utilize hard if-then rules. Other systems use neural networks or statistical models which make soft, probabilistic decisions based on attaching real-valued weights to input features. These models can express the relative probability of multiple answers.

A database 115 may include an organized collection of data. For example, a database 115 may store data in a specified format known as a schema. A database 115 may be structured as a single database, a distributed database, multiple distributed databases, or an emergency backup database. In some cases, a database controller may manage data storage and processing in a database 115. In some cases, a user interacts with database controller. In other cases, database controller may operate automatically without user interaction.

A cloud 120 is a computer network configured to provide on-demand availability of computer system resources, such as data storage and computing power. In some examples, the cloud 120 provides resources without active management by the user 100. The term cloud 120 is sometimes used to describe data centers available to many users 100 over the Internet. Some large cloud 120 networks have functions distributed over multiple locations from central servers. A server is designated an edge server if it has a direct or close connection to a user 100. In some cases, a cloud 120 is limited to a single organization. In other examples, the cloud 120 is available to many organizations. In one example, a cloud 120 includes a multi-layer communications network comprising multiple edge routers and core routers. In another example, a cloud 120 is based on a local collection of switches in a single physical location.

Search engines and site searching are key components in a product search experience. For example, may users (e.g., 43% of users that visit a site) visit such sites to search for a specific product and such searchers are more likely (e.g., 2-3 times more likely) to convert on a purchase. In some examples, users may transition to use other sites if they cannot find the products they are searching for quickly. Therefore, improvement and optimization of search experiences by returning relevant product results can have a dramatic effect on business performance.

Search facet options are a set of product attributes displayed to the user as options to filter the search results. The selection of facet or filter options provided to users as part of the search results page is vital to how users narrow the results and find products to be purchased. For example, if a user searches for blue jeans, the most relevant facet options for that result set might be jeans wash, occasion, inseam, jeans style, etc. Such options enable a user to reduce the items in the search results and find suitable products. Similarly, if a user is searching for sneakers, the jeans-related facet options are less useful. There are different sets of facets that are more appropriate for results of another product. Generally (e.g., in addition to the apparel industry), online sellers in various industries may have diverse catalogs where certain filter options are relevant to a specific set of search results.

Online retailers aim to make online shopping experiences more relevant, and therefore data and artificial intelligence powered solutions are used to automate and optimize relevance of the shopping experience. Product search software provide tools to manually create business rules which determine the facet options that appear in search result pages and provide facet options to users. This creates facet options across product types that are more inclusive and broader (e.g., least common denominator) for diverse catalogs. This further enables providers to hand code rules to cover specific pre-determined search scenarios.

In one example, providers make online shopping experiences more relevant and personal by tailoring the search facet or filter options to suit the requirements of a user. Therefore, the providers ensure that users do not take much time to find products. Advanced platforms and search vendors gives providers the ability to create business rules in pre-determined search scenarios for the time and location of facet options.

Manual facet selection is challenging for multiple reasons. Many product providers have diverse catalogs (i.e., wide variety of products carried). A catalog may contain inclusive (e.g., least-common-denominator) product attributes that apply to multiple product results (e.g., price). Alternatively, catalogs have a product-to-attribute matrix (i.e., attributes and corresponding relevant products) that is sparse (i.e., multiple attributes apply to a small subset of the overall catalog). Some retailers do not control the product data taxonomy and get the product information from suppliers. Therefore, such retailers do not have a normalized set of product attributes. For example, in scenarios such as grocery, department stores, drug stores, office supplies, etc., retailers get product information from the suppliers. Different data schemas of several suppliers need to be integrated. In some cases, product assortments may change (i.e., new products are added or removed). For example, in many industries, buyer or consumer tastes change rapidly or products are seasonal.

Some software platforms provide for administrators to configure rules for which product attributes should appear as facet options for the product listing pages (e.g., search results pages and product category listing pages). Alternatively, software platforms configure a different set of product attributes to be used as facet options per category when the facets are shown on category product listing pages. For instance, when a user navigates to a particular category on the storefront like jackets for women, the software presents a product listing page for that category. In some cases, software platforms provide for administrators to configure rules for which attributes should be presented based on conditional logic. For example, if the query contains the word camera, show facets {a,b,c}, else if the query contains the word phone, show facets etc.

In some cases, manual creation of facet rules that cover most search cases is not feasible. For example, a provider could use web analytics to identify the most common query strings on the site and create manual facet selection rules to handle the most popular queries. In some cases, there are extensive query strings a user can use to search the product catalog. Though, manual writing of rules for the search scenario seen from the users is not possible. Catalogs and user tastes change rapidly, therefore maintaining such a ruleset to account for new products, attributes and consumer search patterns is inefficient. As a result, many websites incorporate sub-optimal faceted navigation experiences on the search pages.

Embodiments of the present disclosure include dynamic and intelligent recommendation for the most relevant set of facet or filter options to a user for any set of search results. The system does not require providers to pre-determine the search scenarios to be covered or manually configure the appearance of facets in a set of search results. The system applies to any type of product catalog and adjusts in real time as catalogs and user search behavior change rapidly. Such a system provides value for online providers with large and diverse product catalogs where creation of a universal rule-set for search facet selection is not possible.

Embodiments of the present disclosure return facets or filter options that are more useful and relevant to the search query of a user 100 (e.g., a browser). The system does not require the provider to develop custom business rules to cover search scenarios (e.g., rules such as: if a user query contains a certain word—show certain facets, etc.).

Systems and techniques described herein enable intelligent faceting that ensures query results for a user are in real time (e.g., faceting of search result objects are selected in parallel with the processing of the search query). For example, search filtering apparatus 110 recommends the most relevant facet options for a specific retrieved set of search results corresponding to a query that is hasn't necessarily ever been seen (e.g., received previously) or submitted (e.g., manually configured in the system). The system (e.g., search filtering apparatus 110) does not necessarily use any pre-configured search scenario by a provider, and the system is robust to changes in product assortment, catalog data, user tastes, search preferences, etc.

Embodiments of the present disclosure may apply to category browse experiences for online stores, where users look at a listing of products in a category. This is valuable for providers with large and complex category hierarchies.

FIG. 2 shows an example of a product search dataflow according to aspects of the present disclosure. The example shown includes database 200, indexing component 205, index database 210, search engine 215, and search preferences 220. Database 200 is an example of, or includes aspects of, the corresponding element described with reference to FIGS. 1 and 6. Indexing component 205 is an example of, or includes aspects of, the corresponding element described with reference to FIG. 6. Search engine 215 is an example of, or includes aspects of, the corresponding element described with reference to FIG. 6.

The search dataflow of FIG. 2 shows an example for a multi-tenant scenario (e.g., a scenario with multiple databases 200, or catalogs, that may be from a same provider or from different providers). In some cases, databases 200 may be referred to as a product catalog (e.g., where each database or product catalog used by one or more services in service of powering the online shopping experience). FIG. 2 further includes an index database 210 (e.g., a projection of the product catalog database 200) optimized for search retrieval, ranking, filtering and aggregation of data. Indexing component 205 may include a search indexing service, for example, responsible for projecting database(s) 200 (e.g., each product catalog) into the search index in the index database 210. Search preferences 220 (e.g., admin search preferences) may include, for example, a set of selections a provider makes for how they want to configure the search experience for online users.

Accordingly, as further described herein, an improved search engine 215 is provided. Search engine 215 may include an online search service (such as a web service) that responds to user (e.g., browser) search queries in real time and responds with catalog search results, as well as facet options. Embodiments of the present disclosure identify the most relevant or useful facet options for any search result set using anomaly detection. Anomaly detection is the process of identifying unexpected items in data sets which differ from the norm. The concept of information gain is used from information theory to identify the attributes that provide maximum discrimination between products in the result set and the rest of the product catalog.

Anomaly detection is applied to problems such as outlier detection in timeseries analysis (i.e., alerting when metrics unexpectedly spike or drop). In some cases, a Sensei-powered feature provides for anomaly detection. Anomaly detection identifies categorical features that are rarely common in certain subsets of data. For example, identifying marketing channels which a certain customer group uses disproportionately more than others, identifying geographical regions that are high risk for particular types of crimes, etc. Embodiments of the present disclosure identify an application of anomaly detection in intelligent faceting. Intelligent faceting refers to automated online facet relevance ranking for selection of the most relevant set of facet or filter options for a search on any product catalog.

A database 200 (e.g., a product catalog) is a source of truth for the product data of the online store. The catalog is used by multiple services in powering the online shopping experience, from creating promotions to processing cart and checkout activities. A database 200 may receive feeds from upstream data sources (e.g., Product Information Systems (PIM) or Enterprise Resource Planning (ERP) systems), which receive feeds from supplier product data. Since the diversity and flow of the product data can be complex, some scenarios are not listed.

Index database 210 is a projection of the database 200 optimized for search retrieval, ranking, filtering and aggregation of data. The data store is an index of the data optimized for the specific use cases around online user search and not a source of truth. Indexing component 205 is the search indexing service responsible for projecting the database 200 into the search index in the search engine database (e.g., index database 210). There are multiple different search engine databases (e.g., Lucene-based search platforms such as SOLR and ElasticSearch) where the indexing, retrieval, and aggregation strategy is designed and built for the intended use cases. The embodiments of the present disclosure include indexing, retrieval and aggregation strategy for intelligent identification of the most relevant facets for a user search results. There is an indexing process that keeps the data in index database 210 in sync with the data in database 200 during update and change.

Search preferences 220 is a set of selections a provider makes to configure the search experience for online users. For example, a relevant set of configuration options is the selection of the subset of overall product attributes that are marked as facetable candidate attributes. Such product attributes can be presented to online users in their search results. Therefore, provider selection of facetable attributes is important since such a selection provides information on the data to be indexed from the database 200 to the index database 210 for purposes of retrieving facet options and identifying the product attributes intended for internal use.

In some examples, search engine 215 may include an online search service (e.g., web service) that responds to user search queries in real time with catalog search results and facet options. The search engine 215 translates a user query into a query of the index database 210 based on the configuration options stored in the search preferences 220, and formats the results to return to the user. The search engine 215 is a foundational part of the online shopping experience and thus has service level agreements for indicators (e.g., uptime, latency, and request throughput).

The system works in single-tenant and multi-tenant search scenarios. In the multi-tenant search scenario, an indexing component 205 service indexes product catalog data from multiple provider online store catalogs. Such scenarios are common with multi-tenant software as a service (SaaS) search provider. The data of the stores is synchronized to the central search service (e.g., search engine 215), and then queries to the service will return product and facet results based on individual stores product catalog. The intelligent faceting algorithm is robust to handle the single tenant and the multi-tenant search scenarios.

A database 200 (e.g., a product catalog) is indexed into a search index (e.g., index database 210) based on administrative rules stored in the search preferences 220, including product attributes that are facetable candidate attributes. As part of the indexing logic, for each product stored in the index database 210, the indexing component 205 indexes the key (i.e., value pairs for products facetable attribute are indexed). For example, a key value pair may be jeans-style: skinny jeans. A separate collection of the facetable candidate attribute keys are indexed. For example, the attribute key jeans style and other attribute keys tagged on the product are indexed. The collection of attribute keys on a product are indexed in a single field so that coverage statistics for each key listed in that field, across the entire catalog is calculated. Different products contain different product attributes, for example, a pair of pants might contain an inseam attribute, but most other items do not have this attribute.

Search engine 215 may include search request interfaces (i.e., application programming interface (API)) to specify the users query and the number of intelligent facets requested. Intelligent facets are calculated online as facets that are most relevant to the query results of a user. Intelligent facets are ranked at query time when the search results, which are a subset of the catalog overall are retrieved. The facetable candidate attribute keys are aggregated and scored or ranked in order of result set description.

The search result set is described by leveraging the concept of information gain from information theory to determine the attributes that best discriminate products in the search results from the rest of the catalog.

For example, if a product has an attribute of jeans-style, there is a 95% chance that such a product is in the search results and a 0.5% chance that the product is not in the search results.

P(in_result_set|has_attribute(“jeans−style”)=0.95

P(not(in_result_set)|has_attribute(“jeans−style”)=0.005

A large amount of information is provided by product attributes to predict if the product is in the result set. Therefore, such an attribute is highly descriptive and relevant to the result set. If an attribute is equally represented in the search results and catalog, much information is not gained by knowing the attribute exists on the product. Thus, there is low relevance to the search results. The process of identifying the most relevant facet options in the result set involves sorting the attributes contained in the search results by a measure of information gain. The most relevant attributes are returned as intelligent facet options.

The facetable candidate attribute contained in the search results are scored according to a significance heuristic to efficiently sort the attributes that are most descriptive or relevant to the result set at query time. The significance heuristic is a measure of the amount an attribute can split or distinguish the search result set from the catalog as a whole. A facet is considered relevant or significant to the search result set when a facet is over-represented in the result compared to the catalog. For example, if a given catalog has 2% of the products with the inseam attribute and 95% of the search result for jeans contain the attribute, the inseam attribute is considered relevant to the search results versus the catalog as a whole (2% of the catalog vs 95% of the results). Alternatively, if an attribute shows up in 95% of the search results and in 95% of the catalog overall, the attribute is less of an outlier attribute.

According to some embodiments, indexing component 205 indexes the set of search candidate objects based on the set of attributes, where the set of search result objects are retrieved based on the indexing. According to some embodiments, indexing component 205 is configured to identify a plurality of attributes for each of the plurality of search candidate objects, and to index the plurality of search candidate objects based on the plurality of attributes, wherein the plurality of search result objects is retrieved based on the indexing.

According to some embodiments, search engine 215 receives a search query. In some examples, search engine 215 retrieves a set of search result objects from among a set of search candidate objects based on the search query. In some examples, the search query includes an unseen query. In some examples, the set of search candidate objects includes a product catalog. According to some embodiments, search engine 215 is configured to receive a search query, and to retrieve the plurality of search result objects from among the plurality of search candidate objects based on the search query.

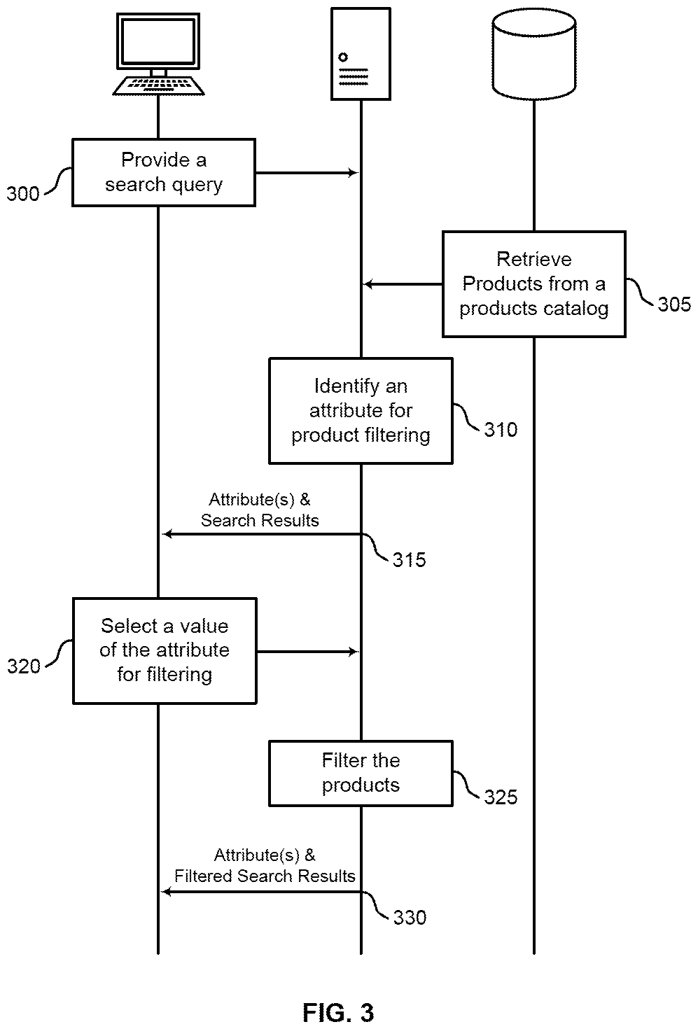

FIG. 3 shows an example of a process for product filtering according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

A method for search refinement is described. One or more embodiments of the method include receiving a search query, retrieving a plurality of search result objects from among a plurality of search candidate objects based on the search query, and identifying an attribute associated with a search result object from the plurality of search result objects. One or more embodiments of the method further include computing an information gain value for the attribute using a significance heuristic based on a frequency of the attribute among the plurality of search result objects and a frequency of the attribute among the plurality of search candidate objects. One or more embodiments of the method further include selecting the attribute as a filter for the plurality of search result objects based on the information gain value and filtering the plurality of search result objects based on a value of the attribute. For instance, the example of FIG. 3 may include operations 300 through 330.

At operation 300, the system provides a search query. In some cases, the operations of this step refer to, or may be performed by, a user as described with reference to FIG. 1.

At operation 305, the system retrieves products from a products catalog. In some cases, the operations of this step refer to, or may be performed by, a database as described with reference to FIGS. 1, 2, and 6.

At operation 310, the system identifies an attribute for filtering the products. In some cases, the operations of this step refer to, or may be performed by, a search filtering apparatus as described with reference to FIGS. 1 and 5.

At operation 315, the system provides a user (e.g., or a user device) with attributes (e.g., facets) and a retrieved set of search results (e.g., search result objects). In some cases, the operations of this step refer to, or may be performed by, a search filtering apparatus as described with reference to FIGS. 1 and 5.

At operation 320, the system selects a value of the attribute for filtering. In some cases, the operations of this step refer to, or may be performed by, a user as described with reference to FIG. 1.

At operation 325, the system filters the products based on the value of the attribute. In some cases, the operations of this step refer to, or may be performed by, a search filtering apparatus as described with reference to FIGS. 1 and 5.

At operation 330, the system provides a user (e.g., or a user device) with attributes (e.g., facets) and a filtered set of search results (e.g., filtered or refined search result objects) based on the user selected value of the attribute for filtering, as well as the filtering at operation 325. In some cases, the operations of this step refer to, or may be performed by, a search filtering apparatus as described with reference to FIGS. 1 and 5.

An apparatus for search refinement is described. The apparatus includes a processor, memory in electronic communication with the processor, and instructions stored in the memory. The instructions are operable to cause the processor to perform the steps of receiving a search query, retrieving a plurality of search result objects from among a plurality of search candidate objects based on the search query, identifying an attribute associated with a search result object from the plurality of search result objects, computing an information gain value for the attribute using a significance heuristic based on a frequency of the attribute among the plurality of search result objects and a frequency of the attribute among the plurality of search candidate objects, selecting the attribute as a filter for the plurality of search result objects based on the information gain value, and filtering the plurality of search result objects based on a value of the attribute.

A non-transitory computer readable medium storing code for search refinement is described. In some examples, the code comprises instructions executable by a processor to perform the steps of: receiving a search query, retrieving a plurality of search result objects from among a plurality of search candidate objects based on the search query, identifying an attribute associated with a search result object from the plurality of search result objects, computing an information gain value for the attribute using a significance heuristic based on a frequency of the attribute among the plurality of search result objects and a frequency of the attribute among the plurality of search candidate objects, selecting the attribute as a filter for the plurality of search result objects based on the information gain value, and filtering the plurality of search result objects based on a value of the attribute.

A system for search refinement is described. One or more embodiments of the system include receiving a search query, retrieving a plurality of search result objects from among a plurality of search candidate objects based on the search query, identifying an attribute associated with a search result object from the plurality of search result objects, computing an information gain value for the attribute using a significance heuristic based on a frequency of the attribute among the plurality of search result objects and a frequency of the attribute among the plurality of search candidate objects, selecting the attribute as a filter for the plurality of search result objects based on the information gain value, and filtering the plurality of search result objects based on a value of the attribute.

Some examples of the method, apparatus, non-transitory computer readable medium, and system further include displaying the filtered plurality of search result objects. Some examples of the method, apparatus, non-transitory computer readable medium, and system further include identifying a plurality of attributes for each of the plurality of search candidate objects. Some examples further include indexing the plurality of search candidate objects based on the plurality of attributes, wherein the plurality of search result objects is retrieved based on the indexing.

Some examples of the method, apparatus, non-transitory computer readable medium, and system further include identifying a plurality of facetable attributes from among the plurality of attributes corresponding to the plurality of search result objects, wherein the attribute is identified from among the plurality of facetable attributes. Some examples of the method, apparatus, non-transitory computer readable medium, and system further include displaying a plurality of values for the attribute on a user interface. Some examples further include receiving an indication via the user interface selecting the value from the plurality of values, wherein the filtering is based on the indication.

In some examples, the search query comprises an unseen query. In some examples, the information gain value is computed based on a JLH score, a mutual information value, a chi square statistic, a normalized distance value, or any combination thereof. In some examples, the plurality of search candidate objects comprises a product catalog.

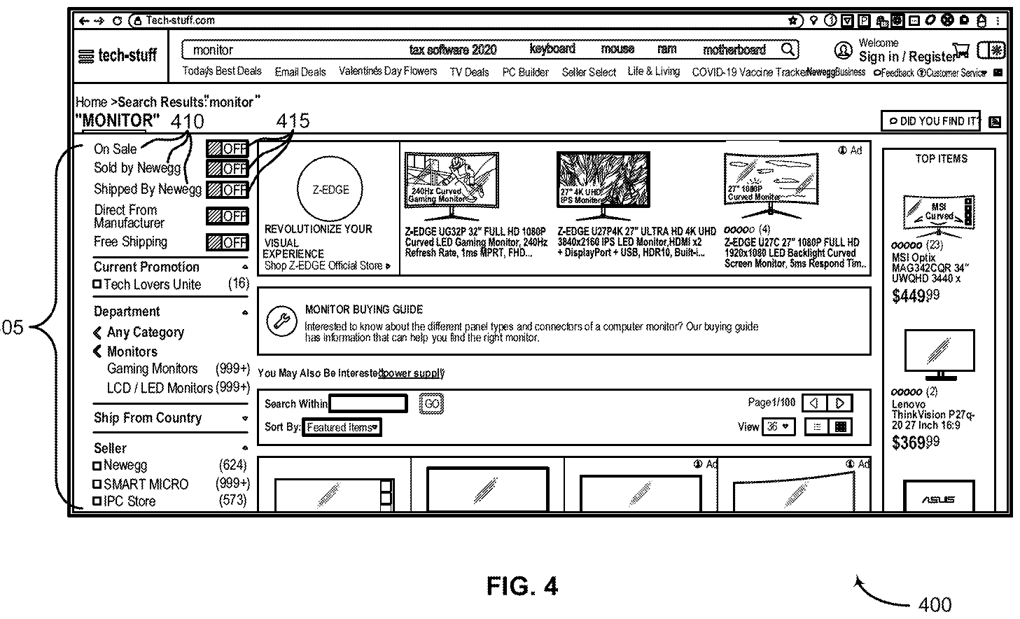

FIG. 4 shows an example of a user interface 400 for search filtering according to aspects of the present disclosure. The example shown includes user interface 400, filter options 405, attribute 410, and value 415. The example of FIG. 4 shows an example of a user interface 400 (e.g., a display screen of a user interface 400). The example user interface 400 displays filter options 405, which include various attributes 410 (e.g., which may be referred to as facets). For instance, examples of attributes 410 may include “On Sale,” “Sold by Newegg,” “Shipped by Newegg,” etc. Each attribute 410 may have a corresponding value 415 (e.g., in the example of FIG. 4, the attributes “On Sale,” “Sold by Newegg,” and “Shipped by Newegg” each have a corresponding value 415 of a toggle “ON/OFF.” A search filtering system may receive a search query (e.g., “monitor”) and provide attributes 410 or facets (in addition to retrieve search results), according to the techniques described herein.

A display may comprise a conventional monitor, a monitor coupled with an integrated display, an integrated display (e.g., an LCD display), or other means for viewing associated data or processing information. Output devices other than the display can be used, such as printers, other computers or data storage devices, and computer networks.

User interface 400 is an example of, or includes aspects of, the corresponding element described with reference to FIG. 6. A user interface 400 may include (or otherwise integrate) an input device. A user interface 400 may enable a user to interact with a device. In some embodiments, the user interface 400 may include an audio device, such as an external speaker system, an external display device such as a display screen, or an input device (e.g., remote control device interfaced with the user interface 400 directly or through an 10 controller module). In some cases, a user interface 400 may be a graphical user interface 400 (GUI). An input device may be a computer mouse, keyboards, keypads, trackballs, and voice recognition devices. An input component may include any combination of devices that allow users to input information into a computing device, such as buttons, a keyboard, switches, and/or dials. In addition, the input component may include a touch-screen digitizer overlaid onto the display that can sense touch and interact with the display.

According to some embodiments, user interface 400 displays the filtered set of search result objects. In some examples, user interface 400 displays a set of values 415 for the attribute 410 on a user interface 400. In some examples, user interface 400 receives an indication via the user interface 400 selecting the value 415 from the set of values 415, where the filtering is based on the indication. According to some embodiments, user interface 400 is configured to display a plurality of values 415 for the attribute 410 on a user interface 400, and to receive an indication via the user interface 400 selecting the value 415 from the plurality of values 415, wherein the filtering is based on the indication.

FIG. 5 shows an example of a search filtering apparatus 500 according to aspects of the present disclosure. The example shown includes search filtering apparatus 500, processor 505, memory 510, attribute identification component 515, significance component 520, and filter component 525. Search filtering apparatus 500 is an example of, or includes aspects of, the corresponding element described with reference to FIG. 1.

An apparatus for search refinement is described. One or more embodiments of the apparatus include an attribute identification component 515 configured to identify an attribute associated with a search result object from a plurality of search result objects, where the plurality of search result objects is selected from a plurality of search candidate objects. One or more embodiments of the apparatus further include a significance component 520 configured to compute an information gain value for the attribute using a significance heuristic based on a frequency of the attribute among the plurality of search result objects and a frequency of the attribute among the plurality of search candidate objects. One or more embodiments of the apparatus further include a filter component 525 configured to select the attribute as a filter for the plurality of search result objects based on the information gain value, and to filter the plurality of search result objects based on a value of the attribute.

A processor 505 is an intelligent hardware device, (e.g., a general-purpose processing component, a digital signal processor 505 (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor 505 is configured to operate a memory 510 array using a memory 510 controller. In other cases, a memory 510 controller is integrated into the processor 505. In some cases, the processor 505 is configured to execute computer-readable instructions stored in a memory 510 to perform various functions. In some embodiments, a processor 505 includes special purpose components for modem processing, baseband processing, digital signal processing, or transmission processing.

Examples of a memory 510 device include random access memory 510 (RAM), read-only memory 510 (ROM), or a hard disk. Examples of memory 510 devices include solid state memory 510 and a hard disk drive. In some examples, memory 510 is used to store computer-readable, computer-executable software including instructions that, when executed, cause a processor 505 to perform various functions described herein. In some cases, the memory 510 contains, among other things, a basic input/output system (BIOS) which controls basic hardware or software operation such as the interaction with peripheral components or devices. In some cases, a memory 510 controller operates memory 510 cells. For example, the memory 510 controller can include a row decoder, column decoder, or both. In some cases, memory 510 cells within a memory 510 store information in the form of a logical state.

A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Attribute identification component 515 is an example of, or includes aspects of, the corresponding element described with reference to FIG. 6. According to some embodiments, attribute identification component 515 identifies an attribute associated with a search result object from the set of search result objects. In some examples, attribute identification component 515 identifies a set of attributes for each of the set of search candidate objects. In some examples, attribute identification component 515 identifies a set of facetable attributes from among the set of attributes corresponding to the set of search result objects, where the attribute is identified from among the set of facetable attributes.

According to some embodiments, attribute identification component 515 identifies an attribute associated with a search result object from a set of search result objects, where the set of search result objects are selected from a set of search candidate objects. In some examples, attribute identification component 515 identifies a set of facetable attributes from among the set of attributes corresponding to the set of search result objects, where the attribute is identified from among the set of facetable attributes. In some examples, attribute identification component 515 identifies a set of values for the attribute. According to some embodiments, attribute identification component 515 is configured to identify an attribute associated with a search result object from a plurality of search result objects, wherein the plurality of search result objects is selected from a plurality of search candidate objects.

Significance component 520 is an example of, or includes aspects of, the corresponding element described with reference to FIG. 6. According to some embodiments, significance component 520 computes an information gain value for the attribute using a significance heuristic based on a frequency of the attribute among the set of search result objects and a frequency of the attribute among the set of search candidate objects. In some examples, the information gain value is computed based on a JLH score, a mutual information value, a chi square statistic, a normalized distance value, or any combination thereof.

According to some embodiments, significance component 520 computes an information gain value for the attribute using a significance heuristic based on a frequency of the attribute among the set of search result objects and a frequency of the attribute among the set of search candidate objects. In some examples, significance component 520 computes a set of information gain values corresponding to the set of facetable attributes. In some examples, significance component 520 computes a first probability representing the frequency of the attribute among the set of search result objects. In some examples, significance component 520 computes a second probability representing the frequency of the attribute among the set of search result objects, where the information gain value is computed based on the first probability and the second probability. In some examples, significance component 520 computes a ratio of the first probability and the second probability. In some examples, significance component 520 computes a difference between the first probability and the second probability. In some examples, significance component 520 computes a product of the ratio and the difference. In some examples, significance component 520 determines a frequency of each of the set of values, where the attribute is selected based at least in part based on the frequency of each of the set of values.

According to some embodiments, significance component 520 is configured to compute an information gain value for the attribute using a significance heuristic based on a frequency of the attribute among the plurality of search result objects and a frequency of the attribute among the plurality of search candidate objects.

According to some embodiments, filter component 525 selects the attribute as a filter for the set of search result objects based on the information gain value. In some examples, filter component 525 filters the set of search result objects based on a value of the attribute. According to some embodiments, filter component 525 selects the attribute as a filter for the set of search result objects based on the information gain value. In some examples, filter component 525 filters the set of search result objects based on a value of the attribute. In some examples, filter component 525 sorts the set of facetable attributes based on the set of information gain values, where the attribute is selected as the filter based on the sorting.

According to some embodiments, filter component 525 is configured to select the attribute as a filter for the plurality of search result objects based on the information gain value, and to filter the plurality of search result objects based on a value of the attribute.

An system for search refinement is described. In some examples, the system may include an attribute identification component 515, a significance component 520, and a filter component 525. The attribute identification component 515 is configured to identify an attribute associated with a search result object from a plurality of search result objects, wherein the plurality of search result objects is selected from a plurality of search candidate objects. The significance component 520 is configured to compute an information gain value for the attribute using a significance heuristic based on a frequency of the attribute among the plurality of search result objects and a frequency of the attribute among the plurality of search candidate objects. The filter component 525 is configured to select the attribute as a filter for the plurality of search result objects based on the information gain value. The filter component 525 may also be configured to filter the plurality of search result objects based on a value of the attribute.

Some examples of the apparatus, system, and method further include a search engine configured to receive a search query, and to retrieve the plurality of search result objects from among the plurality of search candidate objects based on the search query. Some examples of the apparatus, system, and method further include an indexing component configured to identify a plurality of attributes for each of the plurality of search candidate objects, and to index the plurality of search candidate objects based on the plurality of attributes, wherein the plurality of search result objects is retrieved based on the indexing.

Some examples of the apparatus, system, and method further include a database configured to store the plurality of search candidate objects. Some examples of the apparatus, system, and method further include a user interface configured to display a plurality of values for the attribute on a user interface, and to receive an indication via the user interface selecting the value from the plurality of values, wherein the filtering is based on the indication.

FIG. 6 shows an example of a search filtering diagram according to aspects of the present disclosure. The example shown includes user interface 600, indexing component 605, database 610, search engine 615, attribute identification component 620, significance component 625, and filter 630. A search programming interface (i.e., application programming interface (API)) request includes the search query of a user. In some cases, the search programming interface request includes the number of intelligent facets requested. Next, the API ranks the set of intelligent facets in descending order based on a scoring (e.g., a significance heuristic) and returns the selected intelligent facets (e.g., attributes) or values along with the retrieved search results. As a result, for example, a user is presented with the most relevant facet options for filtering their search results.

Indexing component 605 is an example of, or includes aspects of, the corresponding element described with reference to FIG. 2. Indexing component 605 may include a search indexing service, for example, responsible for projecting database(s) 610 (e.g., each product catalog) into a search index in an index database. Database 610 is an example of, or includes aspects of, the corresponding element described with reference to FIGS. 1 and 2.

User interface 600 is an example of, or includes aspects of, the corresponding element described with reference to FIG. 4. In some examples, user interface 600 may receive a search query from the user. Search engine 615 is an example of, or includes aspects of, the corresponding element described with reference to FIG. 2. Search engine 615 may include an online search service (such as a web service) that responds to user search queries in real time and responds with catalog search results (e.g., search result objects), as well as facet options.

Attribute identification component 620 is an example of, or includes aspects of, the corresponding element described with reference to FIG. 5. Attribute identification component 620 may identify one or more attributes of a retrieved set of search result objects according to the techniques described herein.

Significance component 625 is an example of, or includes aspects of, the corresponding element described with reference to FIG. 5. In some examples, significance component 625 determines a score (e.g., a significance heuristic, a JLH score, etc.) which is used as the significance metric of the attribute in the current result set compared to the catalog overall. For example, the JLH score multiplies the relative difference between the proportion of items covered in one set and the proportion of items covered in another set by the absolute differences in the proportions.

(Pₐ/P_{b})*(Pₐ−P_{b})

The JLH score is calculated using the proportional representation of product attribute in the result set versus the proportional representation of the attribute in the catalog as a whole. For example, for scoring attribute A, the score would be:

(P(in_result_set|has_attribute(A))/P(not(in_result_set)|has_attribute(A))*(P(in_result_set|has_attribute(A))−P(not(in_result_set)|has_attribute(A))

The search result retrieval, ranking and intelligent faceting aggregation may be done in a single request, thus increasing the performance and scalability.

Therefore, the system determines the product attributes that describe the result set and ranks the result sets by relevance (e.g., based on the information gain value) to return to the user as facet options for a search result. A filter 630 may include one or more user selected values of the attributes, such that the filter 630 may provide filtered search result objects to the user in accordance with the one or more attribute values.

FIG. 7 shows an example of a process for attribute selection according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 700, the system receives a search query. In some cases, the operations of this step refer to, or may be performed by, a search engine as described with reference to FIGS. 2 and 6.

At operation 705, the system retrieves a set of search results from among a set of search candidate objects based on the search query. In some cases, the operations of this step refer to, or may be performed by, a search engine as described with reference to FIGS. 2 and 6.

At operation 710, the system identifies an attribute associated with a search result object from the set of search result objects. In some cases, the operations of this step refer to, or may be performed by, an attribute identification component as described with reference to FIGS. 5 and 6.

At operation 715, the system computes an information gain value for the attribute using a significance heuristic based on a frequency of the attribute among the set of search result objects and a frequency of the attribute among the set of search candidate objects. In some cases, the operations of this step refer to, or may be performed by, a significance component as described with reference to FIGS. 5 and 6.

At operation 720, the system selects the attribute as a filter for the set of search result objects based on the information gain value. In some cases, the operations of this step refer to, or may be performed by, a filter component as described with reference to FIG. 5.

At operation 725, the system filters the set of search result objects based on a value of the attribute. In some cases, the operations of this step refer to, or may be performed by, a filter component as described with reference to FIG. 5.

FIG. 8 shows an example of a process for computing information gain according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

A method for search refinement is described. One or more embodiments of the method include identifying an attribute associated with a search result object from a plurality of search result objects, where the plurality of search result objects is selected from a plurality of search candidate objects. One or more embodiments of the method further include computing an information gain value for the attribute using a significance heuristic based on a frequency of the attribute among the plurality of search result objects and a frequency of the attribute among the plurality of search candidate objects. One or more embodiments of the method further include selecting the attribute as a filter for the plurality of search result objects based on the information gain value. For instance, the example of FIG. 8 may include operations 800 through 825.

At operation 800, the system computes an information gain value for the attribute using a significance heuristic based on a frequency of the attribute among the set of search result objects and a frequency of the attribute among the set of search candidate objects. In some cases, the operations of this step refer to, or may be performed by, a significance component as described with reference to FIGS. 5 and 6.

At operation 805, the system computes a first probability representing the frequency of the attribute among the set of search result objects. In some cases, the operations of this step refer to, or may be performed by, a significance component as described with reference to FIGS. 5 and 6.

At operation 810, the system computes a second probability representing the frequency of the attribute among the set of search result objects, where the information gain value is computed based on the first probability and the second probability. In some cases, the operations of this step refer to, or may be performed by, a significance component as described with reference to FIGS. 5 and 6.

At operation 815, the system computes a ratio of the first probability and the second probability. In some cases, the operations of this step refer to, or may be performed by, a significance component as described with reference to FIGS. 5 and 6.

At operation 820, the system computes a difference between the first probability and the second probability. In some cases, the operations of this step refer to, or may be performed by, a significance component as described with reference to FIGS. 5 and 6.

At operation 825, the system computes a product of the ratio and the difference. In some cases, the operations of this step refer to, or may be performed by, a significance component as described with reference to FIGS. 5 and 6.

An apparatus for search refinement is described. The apparatus includes a processor, memory in electronic communication with the processor, and instructions stored in the memory. The instructions are operable to cause the processor to perform the steps of identifying an attribute associated with a search result object from a plurality of search result objects, wherein the plurality of search result objects are selected from a plurality of search candidate objects, computing an information gain value for the attribute using a significance heuristic based on a frequency of the attribute among the plurality of search result objects and a frequency of the attribute among the plurality of search candidate objects, and selecting the attribute as a filter for the plurality of search result objects based on the information gain value.

A non-transitory computer readable medium storing code for search refinement is described. In some examples, the code comprises instructions executable by a processor to perform the steps of: identifying an attribute associated with a search result object from a plurality of search result objects, wherein the plurality of search result objects are selected from a plurality of search candidate objects, computing an information gain value for the attribute using a significance heuristic based on a frequency of the attribute among the plurality of search result objects and a frequency of the attribute among the plurality of search candidate objects, and selecting the attribute as a filter for the plurality of search result objects based on the information gain value.

A system for search refinement is described. One or more embodiments of the system include identifying an attribute associated with a search result object from a plurality of search result objects, wherein the plurality of search result objects are selected from a plurality of search candidate objects, computing an information gain value for the attribute using a significance heuristic based on a frequency of the attribute among the plurality of search result objects and a frequency of the attribute among the plurality of search candidate objects, and selecting the attribute as a filter for the plurality of search result objects based on the information gain value.

Some examples of the method, apparatus, non-transitory computer readable medium, and system further include filtering the plurality of search result objects based on a value of the attribute.

Some examples of the method, apparatus, non-transitory computer readable medium, and system further include identifying a plurality of facetable attributes from among the plurality of attributes corresponding to the plurality of search result objects, wherein the attribute is identified from among the plurality of facetable attributes.

Some examples of the method, apparatus, non-transitory computer readable medium, and system further include computing a plurality of information gain values corresponding to the plurality of facetable attributes. Some examples further include sorting the plurality of facetable attributes based on the plurality of information gain values, wherein the attribute is selected as the filter based on the sorting.

Some examples of the method, apparatus, non-transitory computer readable medium, and system further include computing a first probability representing the frequency of the attribute among the plurality of search result objects. Some examples further include computing a second probability representing the frequency of the attribute among the plurality of search result objects, wherein the information gain value is computed based on the first probability and the second probability.

Some examples of the method, apparatus, non-transitory computer readable medium, and system further include computing a ratio of the first probability and the second probability. Some examples further include computing a difference between the first probability and the second probability. Some examples further include computing a product of the ratio and the difference.

Some examples of the method, apparatus, non-transitory computer readable medium, and system further include identifying a plurality of values for the attribute. Some examples further include determining a frequency of each of the plurality of values, wherein the attribute is selected based at least in part based on the frequency of each of the plurality of values.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein. The functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for content management, comprising:
receiving a search query;
retrieving a plurality of search result objects from among a plurality of search candidate objects based on the search query;
identifying an attribute associated with a search result object from the plurality of search result objects;
computing an information gain value for the attribute using a significance heuristic based on a frequency of the attribute among the plurality of search result objects and a frequency of the attribute among the plurality of search candidate objects;
selecting the attribute as a filter for the plurality of search result objects based on the information gain value; and
filtering the plurality of search result objects based on a value of the attribute.

2. The method of claim 1, further comprising:
displaying the filtered plurality of search result objects.

3. The method of claim 1, further comprising:
identifying a plurality of attributes for each of the plurality of search candidate objects; and
indexing the plurality of search candidate objects based on the plurality of attributes, wherein the plurality of search result objects is retrieved based on the indexing.

4. The method of claim 3, further comprising:
identifying a plurality of facetable attributes from among the plurality of attributes corresponding to the plurality of search result objects, wherein the attribute is identified from among the plurality of facetable attributes.

5. The method of claim 1, further comprising:
displaying a plurality of values for the attribute on a user interface; and
receiving an indication via the user interface selecting the value from the plurality of values, wherein the filtering is based on the indication.

6. The method of claim 1, wherein:
the search query comprises an unseen query.

7. The method of claim 1, wherein:
the information gain value is computed based on a JLH score, a mutual information value, a chi square statistic, a normalized distance value, or any combination thereof.

8. The method of claim 1, wherein:
the plurality of search candidate objects comprises a product catalog.

9. A method for content management, comprising:
identifying an attribute associated with a search result object from a plurality of search result objects, wherein the plurality of search result objects is selected from a plurality of search candidate objects;
computing an information gain value for the attribute using a significance heuristic based on a frequency of the attribute among the plurality of search result objects and a frequency of the attribute among the plurality of search candidate objects; and
selecting the attribute as a filter for the plurality of search result objects based on the information gain value.

10. The method of claim 9, further comprising:
filtering the plurality of search result objects based on a value of the attribute.

11. The method of claim 9, further comprising:
identifying a plurality of facetable attributes from among the plurality of attributes corresponding to the plurality of search result objects, wherein the attribute is identified from among the plurality of facetable attributes.

12. The method of claim 11, further comprising:
computing a plurality of information gain values corresponding to the plurality of facetable attributes; and
sorting the plurality of facetable attributes based on the plurality of information gain values, wherein the attribute is selected as the filter based on the sorting.

13. The method of claim 9, further comprising:
computing a first probability representing the frequency of the attribute among the plurality of search result objects; and
computing a second probability representing the frequency of the attribute among the plurality of search result objects, wherein the information gain value is computed based on the first probability and the second probability.

14. The method of claim 13, further comprising:
computing a ratio of the first probability and the second probability;
computing a difference between the first probability and the second probability; and
computing a product of the ratio and the difference.

15. The method of claim 9, further comprising:
identifying a plurality of values for the attribute; and
determining a frequency of each of the plurality of values, wherein the attribute is selected based at least in part based on the frequency of each of the plurality of values.

16. An apparatus for content management, comprising:
an attribute identification component configured to identify an attribute associated with a search result object from a plurality of search result objects, wherein the plurality of search result objects is selected from a plurality of search candidate objects;
a significance component configured to compute an information gain value for the attribute using a significance heuristic based on a frequency of the attribute among the plurality of search result objects and a frequency of the attribute among the plurality of search candidate objects; and
a filter component configured to select the attribute as a filter for the plurality of search result objects based on the information gain value, and to filter the plurality of search result objects based on a value of the attribute.

17. The apparatus of claim 16, further comprising:
a search engine configured to receive a search query, and to retrieve the plurality of search result objects from among the plurality of search candidate objects based on the search query.

18. The apparatus of claim 16, further comprising:
an indexing component configured to identify a plurality of attributes for each of the plurality of search candidate objects, and to index the plurality of search candidate objects based on the plurality of attributes, wherein the plurality of search result objects is retrieved based on the indexing.

19. The apparatus of claim 16, further comprising:
a database configured to store the plurality of search candidate objects.

20. The apparatus of claim 16, further comprising:
a user interface configured to display a plurality of values for the attribute on a user interface, and to receive an indication via the user interface selecting the value from the plurality of values, wherein the filtering is based on the indication.
